(19) United States
(12) Patent Application Publication
(10) Pub. No.: US 2018/0290489 A1
(43) Pub. Date: Oct. 11, 2018

(54) TIRE FOR AGRICULTURAL VEHICLE

(71) Applicant: COMPAGNIE GENERALE DES ETABLISSEMENTS MICHELIN, Clermont-Ferrand (FR)

(72) Inventors: Jean-Luc MANGERET, Clermont-Ferrand Cedex 9 (FR); Anthony MONOD, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/766,259

(22) PCT Filed: Oct. 6, 2016
(86) PCT No.: PCT/FR2016/052573

§ 371 Date: Apr. 5, 2018

(30) Foreign Application Priority Data
Oct. 8, 2015 (FR) 15/59573

(51) Int. Cl. B60C 1/00; B60C 11/03; C08L 9/06; C08L 7/00; C08L 25/10; C08L 57/02; C08K 3/04; C08K 3/36

(52) U.S. Cl. CPC B60C 1/0016; B60C 11/0316; C08L 9/06; C08L 7/00; C08K 2201/006; C08L 57/02; C08K 3/04; C08K 3/36; B60C 2200/08; C08L 25/10

(57) ABSTRACT

The tire has a tread which is intended to come into contact with the ground and which comprises a plurality of lugs separated from one another by grooves. Each lug extends radially outwards, over a radial height H, from a bottom surface as far as a contact face. The grooves are made up of the portions of the bottom surface that separate the lugs. The tread comprises a rubber composition based on at least one synthetic elastomer which predominates by weight, this synthetic elastomer comprising at least one butadiene-styrene copolymer, SBR, the SBR having a content greater than or equal to 20 parts per hundred rubber, phr, a reinforcing filler predominantly comprising carbon black. The composition comprises an aromatic dicyclopentadiene plasticizing resin essentially comprising styrene, ethylene and dicyclopentadiene units, at a content ranging from 2 to 40 phr, the composition containing under 5 phr of another plasticizer.

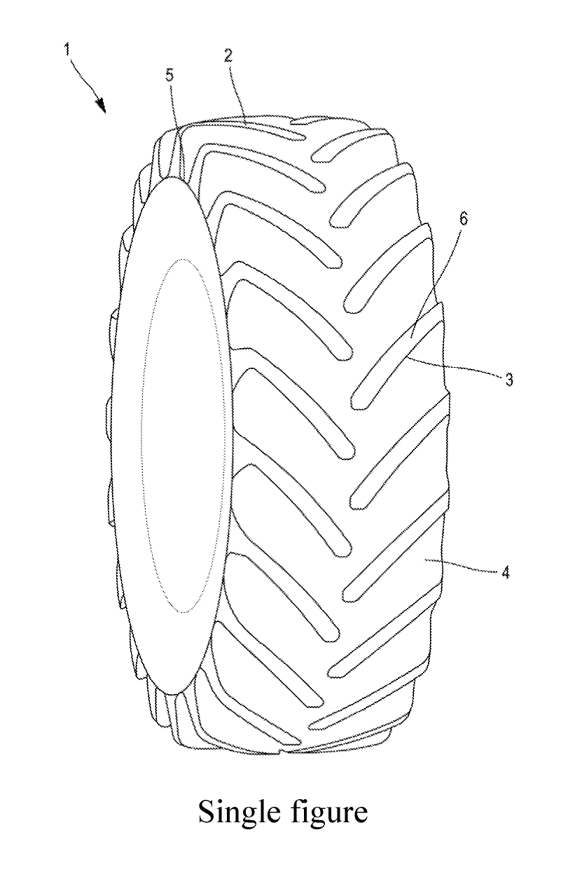

### CROSS-REFERENCE TO RELATED APPLICATION

The present application claims priority to PCT International Patent Application Serial No. PCT/EP2016/052573, filed Oct. 6, 2016, entitled “TIRE FOR AGRICULTURAL VEHICLE,” which claims the benefit of FR Patent Application Serial No. 1559573, filed Oct. 8, 2015.

### BACKGROUND OF THE INVENTION

### 1. Field of the Invention

The present disclosure relates to a tire for an agricultural vehicle, such as an agricultural tractor or an agri-industrial vehicle.

The present disclosure relates more particularly to the tread of such a tire, which tread is intended to come into contact with the ground via a tread surface.

In what follows, the circumferential, axial and radial directions refer respectively to a direction tangential to the tread surface of the tire and oriented in the direction of rotation of the tire, to a direction parallel to the axis of rotation of the tire, and to a direction perpendicular to the axis of rotation of the tire. “Radially inside or, respectively, radially outside” means “closer to or, respectively, further away from the axis of rotation of the tire”. “Axially inside or, respectively, axially outside” means “closer to or, respectively, further away from the equatorial plane of the tire”, the equatorial plane of the tire being the plane passing through the middle of the tread surface of the tire and perpendicular to the axis of rotation of the tire.

Although not restricted to this type of application, the disclosure will be more particularly described with reference to a multipurpose agricultural vehicle capable of being driven both in the fields and on roads, such as an agricultural tractor.

### 2. Related Art

A tire for an agricultural tractor is intended to run over various types of ground such as the more or less compacted soil of the fields, unmade tracks providing access to the fields, and the tarmac surfaces of roads. Bearing in mind the diversity of use, in the fields and on the road, a tire for an agricultural tractor and, in particular, the tread thereof needs to offer a performance compromise between traction in the field, resistance to chunking, resistance to wear on the road, rolling resistance, and vibrational comfort on the road.

The tread of a tire for an agricultural tractor generally comprises a plurality of lugs. The lugs are elements that are raised with respect to a bottom surface which is a surface of revolution about the axis of rotation of the tire.

A lug generally has an elongate parallelepipedal overall shape made up of at least one rectilinear or curvilinear portion, and is separated from the adjacent lugs by grooves. A lug may be made up of a succession of rectilinear portions, as described in documents U.S. Pat. No. 3,603,370, U.S. Pat. No. 4,383,567, EP795427 or may have a curvilinear shape, as set out in documents U.S. Pat. No. 4,446,902, EP903249, EP1831034.

In the radial direction, a lug extends from the bottom surface as far as the tread surface, the radial distance between the bottom surface and the tread surface defining the lug height. The radially outer face of the lug, belonging to the tread surface, which comes into contact with the ground as the lug enters the contact patch in which the tire is in contact with the ground, is known as the contact face of the lug.

In the axial direction, a lug extends inwards, towards the equatorial plane of the tire, from an axially outer end face as far as an axially inner end face.

In the circumferential direction, a lug extends, in a preferred direction of rotation of the tire, from a leading face as far as a trailing face. A preferred direction of rotation means the direction of rotation recommended by the manufacturer of the tire for optimum use of the tire. By way of example, in the case of a tread comprising two rows of lugs configured in a V or chevron formation, the tire has a preferred direction of rotation according to the point of the chevrons. The leading face is, by definition, the face of which the radially outer edge face or leading edge face is first to come into contact with the ground when the lug enters the contact patch in which the tire is in contact with the ground, as the tire rotates. The trailing face is, by definition, the face of which the radially outer edge or trailing edge is last to come into contact with the ground when the lug enters the contact patch in which the tire is in contact with the ground, as the tire rotates. In the direction of rotation, the leading face is said to be forward of the trailing face.

A lug usually, but not necessarily, has a mean angle of inclination with respect to the circumferential direction of close to 45°. This is because this mean angle of inclination in particular allows a good compromise between traction in the field and vibrational comfort. Traction in the field is better if the lug is more axial, that is to say if its mean angle of inclination with respect to the circumferential direction is close to 90°, whereas vibrational comfort is better if the lug is more circumferential, that is to say if its mean angle of inclination with respect to the circumferential direction is close to 0°. It is a well-known fact that traction in the field is more greatly determined by the angle of the lug in the shoulder region, and this has led certain tire designers to offer a very curved lug shape, leading to a lug that is substantially axial at the shoulder and substantially circumferential in the middle of the tread.

The tread of a tire for an agricultural tractor generally comprises two rows of lugs as described above. This distribution of lugs which are inclined with respect to the circumferential direction gives the tread a V shape commonly referred to as a chevron pattern. The two rows of lugs exhibit symmetry about the equatorial plane of the tire, usually with a circumferential offset between the two rows of lugs, resulting from one half of the tread being rotated about the axis of the tire with respect to the other half of the tread. Furthermore, the lugs may be continuous or discontinuous and may be circumferentially distributed with a spacing that is either constant or variable.

The tread of a tire for an agricultural tractor thus comprises two types of element: the lugs, which are the raised elements, and the grooves, which are the portions of the bottom surface separating the lugs. These two types of element experience very different types of stress loadings. The lugs are more particularly sensitive to wear during road use and to attack from stones during non-road or field use. The grooves, between the lugs, are attacked mainly by stubble that remains after harvesting, in field use, and are also sensitive to chemical attack from ozone insofar as these grooves are not subjected to wearing.

### SUMMARY OF THE INVENTION AND ADVANTAGES

The inventors have set themselves the objective of designing a tread for a vehicle for agricultural use that performs better from the standpoint of resistance to attack from residual “stubble” in field use.

The applicant has surprisingly discovered that the use of a specific type of plasticizing resin in compositions for the treads of tires for vehicles for agricultural use allowed a significant improvement in the properties at the limits of these compositions (deformation, stress at break, tearability), which for tires having such treads leads to an improvement in their resistance to attack. The fact that such an improvement has been obtained is all the more astonishing given that in general the addition of plasticizers to these compositions leads to an impairment of the mechanical properties of the compositions, such as, in particular, the properties at the limits.

One subject of the disclosure is therefore a tire for a vehicle for agricultural use comprising a tread intended to come into contact with the ground which comprises a plurality of lugs separated from one another by grooves, each lug extending radially outwards, over a radial height H, from a bottom surface as far as a contact face, the grooves being made up of the portions of the bottom surface that separate the lugs, characterized in that the tread comprises a rubber composition based on at least one synthetic elastomer which predominates by weight, this synthetic elastomer comprising at least one butadiene-styrene copolymer, SBR, the SBR having a content greater than or equal to 20 parts per hundred rubber, phr, a reinforcing filler predominantly comprising carbon black, characterized in that the composition comprises an aromatic dicyclopentadiene plasticizing resin essentially comprising styrene, ethylene and dicyclopentadiene units, at a content ranging from 2 to 40 phr, the composition containing under 5 phr of another plasticizer.

For preference, the plurality of lugs of the tread is distributed between a first row and a second row of lugs which on the whole are symmetrical with respect to the equatorial plane of the tire, which passes through the middle of the tread and is perpendicular to the axis of rotation of the tire.

Advantageously, the carbon black has a CTAB specific surface area greater than or equal to 80 m²/g.

According to one embodiment of the disclosure, the SBR is used in a blend with at least one other diene elastomer, in particular selected from the group consisting of polybutadienes, synthetic polyisoprenes, natural rubber, butadiene copolymers, isoprene copolymers and the mixtures of these elastomers, and more particularly with natural rubber or synthetic polyisoprene.

Preferentially, the carbon black present in the rubber composition represents more than 60% by weight of the sum total of reinforcing filler, and more preferentially still more than 90% by weight of the sum total of reinforcing filler.

Advantageously, the aromatic dicyclopentadiene plasticizing resin comprises at least 90% by weight of units selected from styrene, ethylene and dicyclopentadiene units.

### I. Measurements and Tests Used

The rubber compositions are characterized, after curing, as indicated below.

### Tensile Tests

These tests make it possible to determine the elasticity stresses and the properties at break; those carried out on cured mixtures are carried out in accordance with standard AFNOR-NF-T46-002 of September 1988.

At a temperature of 100° C.±2° C., and under standard hygrometry conditions (50±5% relative humidity), according to French standard NF T 40-101 (December 1979), the stresses at break (in MPa) and the elongations at break (in %) are also measured, the energy at break (breaking energy) being the product of the stress at break and the elongation at break.

### Tearability

The tearability indices are measured at 100° C. The force to be exerted in order to obtain breaking (FRD, in N/mm) is especially determined and the strain at break (DRD, in %) is measured on a test specimen with dimensions of 10×85×2.5 mm notched at the centre of its length with 3 notches over a depth of 5 mm, in order to bring about breaking of the test specimen. Thus, the energy for bringing about breaking (energy) of the test specimen, which is the product of the FRD and DRD, can be determined.

### II. Detailed Description of the Invention

The present disclosure relates to a tire for a vehicle for agricultural use comprising a tread intended to come into contact with the ground which comprises a plurality of lugs separated from one another by grooves, each lug extending radially outwards, over a radial height H, from a bottom surface as far as a contact face, the grooves being made up of the portions of the bottom surface that separate the lugs, characterized in that the tread comprises a rubber composition based on at least one synthetic elastomer which predominates by weight, this synthetic elastomer comprising at least one butadiene-styrene copolymer, SBR, the SBR having a content greater than or equal to 20 parts per hundred rubber, phr, a reinforcing filler predominantly comprising carbon black, characterized in that the composition comprises an aromatic dicyclopentadiene plasticizing resin essentially comprising styrene, ethylene and dicyclopentadiene units, at a content ranging from 2 to 40 phr, the composition containing under 5 phr of another plasticizer.

The expression composition “based on” should be understood as meaning a composition comprising the mixture and/or the reaction product of the various constituents used, some of these base constituents being capable of reacting, or intended to react, with one another, at least in part, during the various phases of manufacture of the composition, in particular during the crosslinking or vulcanization thereof.

In the present description, unless expressly indicated otherwise, all the percentages (%) shown are percentages (%) by weight. Furthermore, any range of values denoted by the expression “between a and b” represents the range of values extending from more than a to less than b (that is to say, limits a and b excluded), whereas any range of values denoted by the expression “from a to b” means the range of values extending from a up to b (that is to say, including the strict limits a and b).

### BRIEF DESCRIPTION OF THE DRAWINGS

The present disclosure will be better understood with the aid of the appended single schematic FIGURE, which has not been drawn to scale, and depicts a perspective view of a tire 1 for a vehicle for agricultural use, such as a tractor.

### DETAILED DESCRIPTION OF THE ENABLING EMBODIMENT

In this FIGURE, the tire 1 has a tread 2, intended to come into contact with the ground via a tread surface, and comprises lugs 3 separated from one another by grooves 4. Each lug 3 extends radially outwards, from a bottom surface 5 as far as a contact face 6, positioned in the tread surface. The grooves 4 consist of the portions of the bottom surface 5 that separate the lugs 3.

In particular, in the case of a tire for an agricultural tractor as depicted in the FIGURE, the plurality of lugs (3) is distributed between a first row and a second row of lugs which on the whole are symmetrical with respect to the equatorial plane of the tire, which passes through the middle of the tread (2) and is perpendicular to the axis of rotation of the tire.

This tread according to the disclosure is based on at least one synthetic elastomer which predominates by weight.

### Diene Elastomer

The term “diene” elastomer (or, equally, rubber), whether natural or synthetic, should be understood in a known way to mean an elastomer consisting at least in part (i.e., a homopolymer or a copolymer) of diene monomer units (monomers bearing two conjugated or non-conjugated carbon-carbon double bonds).

These diene elastomers can be classified into two categories: “essentially unsaturated” or “essentially saturated”. “Essentially unsaturated” is understood to mean generally a diene elastomer resulting at least in part from conjugated diene monomers having a content of units of diene origin (conjugated dienes) which is greater than 15% (mol %); thus it is that diene elastomers such as butyl rubbers or copolymers of dienes and of α-olefins of EPDM type do not come within the preceding definition and can in particular be described as “essentially saturated” diene elastomers (low or very low content, always less than 15%, of units of diene origin). In the category of “essentially unsaturated” diene elastomers, “highly unsaturated” diene elastomer is understood in particular to mean a diene elastomer having a content of units of diene origin (conjugated dienes) which is greater than 50%.

Given these definitions, “diene elastomer capable of being used in the compositions in accordance with the disclosure” is intended more particularly to mean:

(a) —any homopolymer of a conjugated diene monomer, especially any homopolymer obtained by polymerization of a conjugated diene monomer having from 4 to 12 carbon atoms;
(b) —any copolymer obtained by copolymerization of one or more conjugated dienes with one another or with one or more vinylaromatic compounds having from 8 to 20 carbon atoms;
(c) —a ternary copolymer obtained by copolymerization of ethylene, of an α-olefin having from 3 to 6 carbon atoms with a non-conjugated diene monomer having from 6 to 12 carbon atoms, such as, for example, the elastomers obtained from ethylene, and of propylene with a non-conjugated diene monomer of the abovementioned type, such as, especially, 1,4-hexadiene, ethylidene norbornene or dicyclopentadiene;
(d) —a copolymer of isobutene and of isoprene (butyl rubber) and also the halogenated versions, in particular chlorinated or brominated versions, of this type of copolymer.

Although it applies to any type of diene elastomer, a person skilled in the art of tires will understand that the present disclosure is preferably employed with essentially unsaturated diene elastomers, in particular of the above type (a) or (b).

The elastomer matrix of the composition in accordance with the disclosure predominantly comprises a synthetic elastomer. This comprises at least one butadiene-styrene copolymer, SBR, with a content of greater than or equal to 20, preferably with a content ranging from 30 to 100 phr, more preferentially from 40 to 100 phr.

The SBR may advantageously be used in a blend with one or more other diene elastomers, especially selected from the group consisting of polybutadienes, synthetic polyisoprenes, natural rubber, butadiene copolymers, isoprene copolymers, butadiene-styrene copolymers and the mixtures of these elastomers.

In particular, the SBR may be used in a blend with natural rubber or a synthetic polyisoprene, present at a content ranging from 5 to 40 phr and preferentially ranging from 15 to 40 phr.

The SBR may also advantageously be used in a blend with polybutadiene, BR, present at a content ranging from 5 to 40 phr and preferably from 10 to 30 phr.

According to one preferred embodiment of the disclosure, the SBR is used in a blend with NR or with IR in the proportions given hereinabove, and with BR also in the proportions indicated hereinabove.

The abovementioned elastomers may have any microstructure, which depends on the polymerization conditions used, especially on the presence or absence of a modifying and/or randomizing agent and on the amounts of modifying and/or randomizing agent employed. The elastomers can, for example, be block, random, sequential or microsequential elastomers and can be prepared in dispersion or in solution; they can be coupled and/or star-branched or else functionalized with a coupling and/or star-branching or functionalization agent. For coupling to carbon black, mention may for example be made of functional groups comprising a C—Sn bond or amino functional groups, such as aminobenzophenone, for example; for coupling to a reinforcing mineral filler such as silica, mention may for example be made of silanol functional groups or polysiloxane functional groups having a silanol end (such as described, for example, in FR 2 740 778 or U.S. Pat. No. 6,013,718 and WO 2008/141702), alkoxysilane groups (such as described, for example, in FR 2 765 882 or U.S. Pat. No. 5,977,238), carboxyl groups (such as described, for example, in WO 01/92402 or U.S. Pat. No. 6,815,473, WO 2004/096865 or US 2006/0089445) or else polyether groups (such as described, for example, in EP 1 127 909 or U.S. Pat. No. 6,503,973, WO 2009/000750 and WO 2009/000752).

As functional elastomers, mention may also be made of those prepared using a functional initiator, especially those bearing an amine or tin functional group (see, for example, WO 2010/072761).

Mention may also be made, as other examples of functionalized elastomers, of elastomers (such as SBR, BR, NR or IR) of the epoxidized type.

In particular it is highly advantageous, irrespective of whether it is blended with other elastomers, to use a blend of SBR with another SBR so that the composition contains a non-functional SBR and a functional SBR both as described hereinabove.

For preference, the functional SBR is an SBR that has been functionalized with a coupling agent, and more preferably still this is a tin-coupled SBR.

Also as a preference, the non-functional SBR is a star-branched SBR.

It will be noted that the SBR may be prepared as emulsion (ESBR) or as solution (SSBR). Whether it is ESBR or SSBR, use is especially made of an SBR having a moderate styrene content, for example of between 10% and 35% by weight, or a high styrene content, for example from 35% to 55%, a content of vinyl bonds of the butadiene part of between 15% and 70%, a content (mol %) of trans-1,4-bonds of between 15% and 75% and a Tg of between −10° C. and −65° C., preferably of greater than or equal to −50° C.

The composition according to the disclosure may contain one or more synthetic elastomers other than diene elastomers, or even with polymers other than elastomers, for example thermoplastic polymers.

### Reinforcing Filler

In the present description, the CTAB specific surface area is determined according to French standard NF T 45-007 of November 1987 (method B).

The composition of the disclosure comprises at least one reinforcing filler comprising predominantly, that is to say at a content of greater than or equal to 50% by weight.

Of these, carbon blacks having a CTAB specific surface area of greater than or equal to 90 m²/g, and preferably less than or equal to 140 m²/g, are particularly suitable. Mention will more particularly be made of the reinforcing carbon blacks of the 100, 200 or 300 series (ASTM grade), such as, for example, the N115, N134, N234 or N330 blacks. Of course, a blend of two carbon blacks having the abovementioned features is suitable for the disclosure.

Blacks having a “low” structure, that is to say having a COAN number of less than 95 ml/g, may also be suitable.

It will be noted that the oil absorption number of compressed samples of carbon black (COAN) is a measure of the ability of the carbon black to absorb liquids. This property is itself a function of the structure of the carbon black. The COAN number is determined using standard ISO 4656/2012 using an absorptometer with compressed samples of carbon black.

It will be noted that the carbon blacks may for example be already incorporated in the SBR, or the NR where appropriate, especially isoprene-based, in the form of a masterbatch produced by dry or liquid route (see, for example, applications WO 97/36724 or WO 99/16600).

This carbon black advantageously constitutes more than 60% by weight of the total reinforcing filler, preferably more than 70% and even more preferentially 90% by weight of the total reinforcing filler of the composition.

The carbon black may advantageously represent the only reinforcing filler of the composition.

According to one embodiment variant of the disclosure, the carbon black having the abovementioned CTAB specific surface area may be used in a blend with another reinforcing filler, in a minor amount, preferentially at a content of between 1 and 10 phr. This other reinforcing filler may consist of any type of reinforcing filler known for its abilities to reinforce a rubber composition which can be used for the manufacture of tires.

For example, another organic filler such as another carbon black, functionalized polyvinylaromatic organic fillers such as those described in applications WO-A-2006/069792 and WO-A-2006/069793, a reinforcing inorganic filler such as silica, with which a coupling agent is combined, in a known way, or else a mixture of these different fillers.

Thus, the term “inorganic filler” should be understood here to mean, in a known way, any inorganic or mineral filler, irrespective of its colour and its origin (natural or synthetic), also known as “white filler”, “clear filler” or also “non-black filler”, in contrast to carbon black, this inorganic filler being capable of reinforcing, by itself, without means other than an intermediate coupling agent, a rubber composition intended for the manufacture of a tire tread, in other words capable of replacing, in its reinforcing role, a conventional tire-grade carbon black for a tread. Such a filler is generally characterized by the presence of functional groups, especially hydroxyl (OH) functional groups, at its surface, requiring, in order to be used as reinforcing filler, the use of a coupling agent or system intended to provide a stable chemical bond between the isoprene elastomer and said filler. Such an inorganic filler may thus be used with a coupling agent in order to enable the reinforcement of the rubber composition in which it is included. It may also be used with a covering agent (which does not provide a bond between the filler and the elastomeric matrix), in addition to a coupling agent or not (in this case, the inorganic filler does not act as reinforcement).

The physical state in which the inorganic filler is provided is not important, whether it is in the form of a powder, micropearls, granules, beads or any other appropriate densified form. Of course, the term “inorganic filler” is also understood to mean mixtures of various inorganic fillers, in particular of highly dispersible siliceous and/or aluminous fillers, as described below.

Mineral fillers of the siliceous type, in particular silica (SiO2), or of the aluminous type, in particular alumina (Al2O3), are suitable in particular as inorganic fillers. The silica used may be any silica known to those skilled in the art, especially any precipitated or fumed silica exhibiting a BET surface area and a CTAB specific surface area which are both less than 450 m²/g, preferably from 30 to 400 m²/g. Mention will be made, as highly dispersible precipitated silicas (“HDSs”), for example, of the Ultrasil 7000 and Ultrasil 7005 silicas from Evonik, the Zeosil 1165MP, 1135MP and 1115MP silicas from Rhodia, the Hi-Sil EZ150G silica from PPG, the Zeopol 8715, 8745 and 8755 silicas from Huber or the silicas with a high specific surface area as described in application WO 03/16837.

The BET specific surface area is determined in a known way by gas adsorption using the Brunauer-Emmett-Teller method described in The Journal of the American Chemical Society, Vol. 60, page 309, February 1938, more specifically according to French standard NF ISO 9277 of December 1996 (multipoint (5 point) volumetric method—gas: nitrogen—degassing: 1 hour at 160° C.—relative pressure p/po range: 0.05 to 0.17).

It is also possible to envisage the addition, to the specific carbon black of the composition, of other fillers in a minor amount, preferably at a content of less than or equal to 10 phr, such as carbon blacks partially or completely covered with silica via a post-treatment or the carbon blacks modified in situ by silica, such as, nonlimitingly, the fillers sold by Cabot Corporation under the name Ecoblack™ CRX 2000 or CRX 4000.

Preferentially, the total content of filler (carbon black and other fillers, where appropriate) is between 20 and 150 phr, and more preferentially between 20 and 100 phr.

The carbon black according to the disclosure is present at a content ranging from 20 to 90 phr, more preferentially from 30 to 80 phr and even more preferentially from 45 to 65 phr.

### Plasticizing Resin

As is known to the person skilled in the art, the designation “plasticizing resin” is reserved in the present patent application, by definition, for a compound which is, on the one hand, solid at ambient temperature (23° C.) (in contrast to a liquid plasticizing compound, such as an oil).

Hydrocarbon-based resins are polymers well known to those skilled in the art which are miscible by nature in diene elastomer composition(s), when they are additionally classed as “plasticizing”. They have been described, for example, in the work entitled “Hydrocarbon Resins” by R. Mildenberg, M. Zander and G. Collin (New York, V C H, 1997, ISBN 3-527-28617-9), Chapter 5 of which is devoted to their applications, especially in the tire rubber field (5.5. “Rubber Tires and Mechanical Goods”). They may be aliphatic, aromatic or else of the aliphatic/aromatic type, that is to say based on aliphatic and/or aromatic monomers. They can be natural or synthetic and based or not based on petroleum (if such is the case, they are also known under the name of petroleum resins). They are preferentially exclusively hydrocarbon-based, i.e. they comprise only carbon and hydrogen atoms.

The glass transition temperature, Tg, is measured in a known way by DSC (Differential Scanning calorimetry) according to standard ASTM D3418 (1999). The macrostructure (Mw, Mn and PI) of the hydrocarbon-based resin is determined by size exclusion chromatography (SEC); solvent tetrahydrofuran; temperature 35° C.; concentration 1 g/1; flow rate 1 ml/min; solution filtered through a filter with a porosity of 0.45 μm before injection; Moore calibration with polystyrene standards; set of 3 Waters columns in series (Styragel HR4E, HR1 and HR0.5); detection by differential refractometer (Waters 2410) and its associated operating software (Waters Empower).

It is known practice to use, in rubber compositions for tires, hydrocarbon-based plasticizing resins having at least any one of the following features:
a Tg of greater than 20° C., more preferentially of greater than 30° C.;
a number-average molecular weight (Mn) of between 400 and 2000 g/mol;
a polydispersity index (PI) of less than 4, preferentially of less than 3 (as a reminder: PI=Mw/Mn, with Mw the weight-average molecular weight).

More preferentially, this hydrocarbon-based plasticizing resin exhibits all of the above preferred features.

In particular, it is known practice to select these plasticizing resins from the group consisting of cyclopentadiene (abbreviated to CPD) or dicyclopentadiene (abbreviated to DCPD) homopolymer or copolymer resins, terpene homopolymer or copolymer resins, C5 fraction homopolymer or copolymer resins and the mixtures of these resins.

The applicant has discovered that, among these aromatic dicyclopentadiene plasticizing to resins, the dicyclopentadiene resins comprising essentially styrene, ethylene and dicyclopentadiene units, used in compositions based predominantly on synthetic elastomers and on black, astonishingly made it possible to obtain improved properties. “Essentially” is understood to mean the fact that the resins comprise at least 80% of units selected from styrene, ethylene and dicyclopentadiene units.

More preferentially still, the aromatic dicyclopentadiene plasticizing resins suitable for the disclosure comprise at least 90% of units selected from styrene, ethylene and dicyclopentadiene units.

By way of examples of resins in accordance with the disclosure, aromatic dicyclopentadiene plasticizing resins having a content of dicyclopentadiene units of between 10 and 30% such as, especially, the commercial resins Novares TC160 (Mn=710 g/mol; Mw=2000 g/mol; PI=2.8, Tg=106° C.) or Novares TC100 (Mn=460 g/mol; Mw=840 g/mol; PI=1.8, Tg=42° C.) sold by the company Rutgers, the resins QUINTONE sold by the company Nippon Zeon, the resins LX1200-130 or NEVROZ1420 sold by the company Neville.

The content of aromatic dicyclopentadiene resin preferentially ranges from 2 to 40 phr. Preferentially, the content of aromatic dicyclopentadiene resin ranges from 2 to 20 phr when the rubber composition comprises a content of carbon black, in accordance with the disclosure, of less than or equal to 65 phr, more preferentially the content of plasticizing resin ranges from 2 to 10 phr, and even more preferentially from 3 to 7 phr.

Below the indicated minimum, the targeted technical effect may prove insufficient, whereas above the upper limit, the compromise of properties targeted for the rubber composition in question is no longer achieved.

### Crosslinking System

The crosslinking system is preferably a vulcanization system, i.e. a system based on sulfur (or on a sulfur-donating agent) and on a primary vulcanization accelerator. Various known secondary vulcanization accelerators or vulcanization activators, such as zinc oxide, stearic acid or equivalent compounds, or guanidine derivatives (in particular diphenylguanidine), are added to this base vulcanization system, being incorporated during the first non-productive phase and/or during the productive phase, as described subsequently.

The sulfur is used at a preferential content of between 0.5 and 12 phr, in particular between 1 and 10 phr. The primary vulcanization accelerator is used at a preferential content of between 0.5 and 10 phr, more preferentially of between 0.5 and 5.0 phr.

Use may be made, as (primary or secondary) accelerator, of any compound capable of acting as accelerator for the vulcanization of diene elastomers in the presence of sulfur, especially accelerators of thiazole type, and also their derivatives, and accelerators of thiuram and zinc dithiocarbamate types. These accelerators are, for example, selected from the group consisting of 2-mercaptobenzothiazole disulfide (abbreviated to “MBTS”), tetrabenzylthiuram disulfide (“TBZTD”), N-cyclohexyl-2-benzothiazolesulfenamide (“CBS”), N,N-dicyclohexyl-2-benzothiazolesulfenamide (“DCBS”), N-(tert-butyl)-2-benzothiazolesulfenamide (“TBBS”), N-(tert-butyl)-2-benzothiazolesulfenimide (“TBSI”), zinc dibenzyldithiocarbamate (“ZBEC”) and the mixtures of these compounds.

### Various Additives

The rubber compositions in accordance with the disclosure may also comprise all or some of the customary additives generally used in elastomer compositions intended for the manufacture of tires, in particular of treads, such as, for example, protective agents such as antiozone waxes, chemical antiozonants, antioxidants, antifatigue agents, tackifying resins, processing aids such as described, for example, in application WO 02/10269, a crosslinking system based either on sulfur or on sulfur donors and/or on peroxide and/or on bismaleimides, vulcanization accelerators or vulcanization activators.

However, the rubber composition in accordance with the disclosure may only comprise a plasticizer other than the aromatic dicyclopentadiene plasticizing resin at a content of less than 5 phr, preferably less than 2 phr, preferentially less than 1 phr.

Even more preferentially, the rubber composition in accordance with the disclosure is devoid of plasticizer other than the aromatic dicyclopentadiene plasticizing resin.

Depending on the targeted application, inert (i.e. non-reinforcing) fillers, such as particles of clay, bentonite, talc, chalk, kaolin, at a content of less than or equal to 10 phr and preferentially less than or equal to 5 phr, may also be added to the reinforcing filler described above.

### Manufacture of the Rubber Compositions

The rubber compositions of the disclosure are manufactured in appropriate mixers, using two successive phases of preparation according to a general procedure well known to those skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at lower temperature, typically below 120° C., for example between 60° C. and 100° C., during which finishing phase the crosslinking or vulcanization system is incorporated.

### III. Exemplary Embodiments of the Invention

The examples which follow make it possible to illustrate the disclosure; however, the disclosure cannot be limited to these examples alone.

### III-1 Preparation of the Rubber Compositions

The following tests are carried out in the following way: the SBR, the carbon black and then, after kneading for one to two minutes, the various other ingredients, especially the plasticizing resin where appropriate, with the exception of the vulcanization system, are introduced into an internal mixer which is 70% filled and the initial vessel temperature of which is approximately 90° C. Thermomechanical working is then carried out (non-productive phase) in one step (total duration of the kneading equal to approximately 5 min), until a maximum “dropping” temperature of approximately 165° C. is reached. The mixture thus obtained is recovered and cooled and then the covering agent (when the latter is present) and the vulcanization system (sulfur and sulfenamide accelerator) are added on an external mixer (homofinisher) at 70° C., everything being mixed (productive phase) for approximately 5 to 6 min.

The compositions thus obtained are subsequently calendered in the form of slabs (thickness of 2 to 3 mm) of rubber for the measurement of their physical or mechanical properties.

### III-2 Test

The aim of this test is to demonstrate the improved properties of rubber compositions for agricultural tire treads in accordance with the disclosure compared to compositions not in accordance with the disclosure which are devoid of aromatic dicyclopentadiene resins.

In order to do that, 6 compositions based on a blend E containing 35 phr of non-functional SBR, 35 phr of functional (tin-coupled) SBR, and 35 phr of NR, or on a blend F containing 45 phr of non-functional SBR, 35 phr of NR, and 20 phr of BR, both reinforced with carbon black alone or as a blend of carbon black with silica, are compared, these compositions differing from one another essentially in terms of the following technical features:
the composition T1 is a control composition, based on a blend E, containing only carbon black and containing no aromatic dicyclopentadiene plasticizing resin,
the composition T2 is a second control composition, based on a blend E, containing a blend of carbon black and silica, but containing no aromatic dicyclopentadiene plasticizing resin,
the composition T3 is a third control composition, based on a blend F, containing only carbon black and containing no aromatic dicyclopentadiene plasticizing resin,
the composition C1 according to the disclosure, based on a blend E, contains carbon black and an aromatic dicyclopentadiene plasticizing resin,
the composition C2 according to the disclosure, based on a blend E, contains a blend of carbon black and silica, and an aromatic dicyclopentadiene plasticizing resin,
the composition C3 according to the disclosure, based on a blend F, contains carbon black and an aromatic dicyclopentadiene plasticizing resin.

Tables 1 and 2 give the formulations of the various compositions (Table 1—contents of the various products, expressed in phr) and their properties after curing for approximately 40 min at 150° C. (Table 2); the vulcanization system consists of sulfur and sulfenamide.

In the light of Table 2, it would seem, astonishingly, that the compositions C1, C2 and C3 according to the disclosure allow a very significant improvement in relation to the compositions T1, T2 and T3 respectively, in breaking energy (both elongation at break and stress at break) but also in the tearability properties (values of DRD and FRD).

Now, this observation is true both for the various elastomeric matrices (compositions T1, C1, T2 and C2 with SBR/NR 65/35 and compositions T3 and C3 with SBR/NR/BR 45/35/20), and for the various blends and types of filler (compositions T1, C1, T3 and C3 with black N234 alone, compositions T2 and C2 with an N115/Si blend).

Thus, these examples show that the use of aromatic dicyclopentadiene plasticizing resin in rubber compositions based predominantly on synthetic elastomers and carbon black, containing very little or no other plasticizers, for the tread of tires for vehicles for agricultural use, allows a significant and surprising improvement to the properties of these compositions at the limits and therefore to the resistance of such tires to attack.

TABLE 1

| Compositions | T1 | T2 | T3 | C1 | C2 | C3 |
|---|---|---|---|---|---|---|
| SBR (1) | 35 | 35 | 45 | 35 | 35 | 45 |
| SBR (2) | 30 | 30 | — | 30 | 30 | — |
| NR (3) | 35 | 35 | 35 | 35 | 35 | 35 |
| BR (4) | — | — | 20 | — | — | 20 |
| Carbon black (5) | 50 | — | 50 | 50 | — | 50 |
| Carbon black (6) | — | 50 | — | — | 50 | — |
| Silica (7) | — | 5 | — | — | 5 | — |
| Plasticizing resin (8) | — | — | — | 3 | 3 | — |
| Plasticizing resin (9) | — | — | — | — | — | 4 |
| Antioxidant (10) | 1.5 | 1.5 | 1.5 | 1.5 | 1.5 | 1.5 |
| Zinc oxide (11) | 2.5 | 2.5 | 2.5 | 2.5 | 2.5 | 2.5 |
| Stearic acid (12) | 2 | 2 | 2 | 2 | 2 | 2 |
| Sulfur | 1.4 | 1.4 | 1.4 | 1.4 | 1.4 | 1.4 |
| Accelerator (13) | 0.7 | 0.7 | 0.7 | 0.7 | 0.7 | 0.7 |

(1) Non-extended SSBR with 26.5% of styrene, 24% of 1,2-polybutadiene units and 50% of trans-1,4-polybutadiene units (Tg = −48° C.);
(2) Tin-coupled, non-extended SSBR with 15.5% of styrene, 24% of 1,2-polybutadiene units and 48% of trans-1,4-polybutadiene units (Tg = −65° C.);
(3) Natural rubber;
(4) BR (Nd) with 0.5% of 1,2-; 1.2% of trans-; 98.3% of cis-1,4- (Tg = −108° C.);
(5) N234 sold by Cabot Corporation;
(6) N115 sold by Cabot Corporation;
(7) Ultrasil 7000 Silica, sold by Evonik;
(8) Novares TC100 resin (Mn = 460 g/mol; Mw = 840 g/mol; PI = 1.8, Tg = 42° C.) sold by Rutgers;
(9) Novares TC160 resin (Mn = 710 g/mol; Mw = 2000 g/mol; PI = 2.8, Tg = 106° C.) sold by Rutgers;
(10) N-(1,3-Dimethylbutyl)-N-phenyl-para-phenylenediamine (Santoflex 6-PPD from Flexsys);
(11) Zinc oxide (industrial grade ? Umicore);
(12) Stearin (Pristerene 4931 Uniqema);
(13) N-Cyclohexyl-2-benzothiazolesulfenamide (Santocure CBS from Flexsys).

TABLE 2

| Compositions | T1 | T2 | T3 | C1 | C2 | C3 |
|---|---|---|---|---|---|---|
| Elongation at | 532 | 576 | 493 | 692 | 636 | 610 |
| break (%) | | | | | | |
| Stress at break | 14.9 | 14.8 | 13.8 | 15.2 | 15.3 | 13.9 |
| (MPa) | | | | | | |
| Breaking | 79.45 | 85.19 | 68.09 | 105.31 | 97.37 | 84.73 |
| energy (MJ) | | | | | | |
| DRD (%) | 181 | 204 | 160 | 236 | 239 | 241 |
| FRD (N/mm) | 27.5 | 29.1 | 24.0 | 31.4 | 30.7 | 30.5 |

What is claimed is:

1) A tire for a vehicle for agricultural use comprising a tread intended to come into contact with the ground which comprises a plurality of lugs separated from one another by grooves, each lug extending radially outwards, over a radial height H, from a bottom surface as far as a contact face, the grooves being made up of the portions of the bottom surface that separate the lugs, wherein the tread comprises a rubber composition based on at least one synthetic elastomer which predominates by weight, this synthetic elastomer comprising at least one butadiene-styrene copolymer, SBR, the SBR having a content greater than or equal to 20 parts per hundred rubber, phr, a reinforcing filler predominantly comprising carbon black, characterized in that the composition comprises an aromatic dicyclopentadiene plasticizing resin essentially comprising styrene, ethylene and dicyclopentadiene units, at a content ranging from 2 to 40 phr, the composition containing under 5 phr of another plasticizer.

2) The tire according to claim 1, in which the plurality of lugs of the tread is distributed between a first row and a second row of lugs which on the whole are symmetrical with respect to the equatorial plane of the tire, which passes through the middle of the tread and is perpendicular to the axis of rotation of the tire.

3) The tire according to claim 1, in which the carbon black has a CTAB specific surface area greater than or equal to 80 m²/g.

4) The tire according to claim 1, in which the SBR content ranges from 40 to 100 phr.

5) The tire according to claim 1, in which the SBR is used in a blend with at least one other diene elastomer.

6) The tire according to claim 5, in which the other diene elastomer is selected from the group consisting of polybutadienes, synthetic polyisoprenes, natural rubber, butadiene copolymers, isoprene copolymers, butadiene-styrene copolymers and the mixtures of these elastomers.

7) The tire according to claim 6, in which the SBR is used as a blend with another SBR so that the composition contains a non-functional SBR and a functional SBR.

8) The tire according to claim 7, in which the functional SBR is an SBR that has been functionalized with a coupling agent, preferably a tin-coupled SBR.

9) The tire according to claim 7, in which the non-functional SBR is a star-branched SBR.

10) The tire according to claim 6, in which the SBR is used in a blend with natural rubber or synthetic polyisoprene, present at a content ranging from 5 to 40 phr.

11) The tire according to claim 10, in which the natural rubber or synthetic polyisoprene is present at a content ranging from 15 to 40 phr.

12) The tire according to claim 6, in which the SBR is used in a blend with polybutadiene, present at a content ranging from 5 to 40 phr.

13) The tire according to claim 12, in which the polybutadiene is present at a content ranging from 10 to 30 phr.

14) The tire according to claim 1, in which the carbon black represents more than 60% by weight of the sum total of reinforcing filler.

15) The tire according to claim 14, in which the carbon black represents more than 90% by weight of the sum total of reinforcing filler.

16) The tire according to claim 15, in which the carbon black is the only reinforcing filler.

17) The tire according to claim 1, in which the reinforcing filler also comprises an inorganic filler, preferably silica.

18) The tire according to claim 1, in which the aromatic dicyclopentadiene plasticizing resin comprises at least 90% by weight of units selected from styrene, ethylene and dicyclopentadiene units.

19) The tire according to claim 1, in which the composition is devoid of plasticizer other than the aromatic dicyclopentadiene plasticizing resin.

20) The tire according to claim 1, in which the content of carbon black is less than or equal to 65 phr, and the content of aromatic dicyclopentadiene resin ranges from 2 to 20 phr.

21) The tire according to claim 20, in which the content of plasticizing resin ranges from 2 to 10 phr, preferably from 3 to 7 phr.
